(19) United States
(12) Patent Application Publication
(10) Pub. No.: US 2014/0149889 A1
(43) Pub. Date: May 29, 2014

(54) INPUT ASSOCIATIONS FOR TOUCH SENSITIVE SURFACE

(71) Applicant: Nigel Pearce, Lancashire (GB)

(72) Inventor: Nigel Pearce, Lancashire (GB)

(73) Assignee: PROMETHEAN LIMITED, Lancashire (GB)

(21) Appl. No.: 13/879,575

(22) PCT Filed: Oct. 12, 2011
(86) PCT No.: PCT/EP2011/067778

§ 371 Date: Aug. 22, 2013

(30) Foreign Application Priority Data
Oct. 15, 2010 (GB) 1017505.7

(51) Int. Cl. G06F 3/0481; G06F 3/0482; G06F 3/0486

(52) U.S. Cl. CPC G06F 3/04817; G06F 3/0486; G06F 3/0482
USPC 715/753

(57) ABSTRACT

There is disclosed a method of collaborative working at a touch sensitive surface of a collaborative input system, the method comprising: a. selecting, by touch, at the touch sensitive surface, a displayed icon; b. providing further inputs, by touch, at the touch sensitive surface, wherein the further inputs are associated with the selected icon.

### BACKGROUND TO THE INVENTION

1. Field of the Invention

The present invention relates to touch sensitive interactive surfaces, which in use may be presented in a horizontal or vertical arrangement, and is particularly but not exclusively concerned with such surfaces being provided with touch inputs from a plurality of different sources.

2. Description of the Related Art

Interactive surfaces which are adapted to detect touch inputs are well-known in the art. Such an interactive surface may be arranged to have a display to display graphical information and/or images to a user. A user is able to touch the surface at a position at which an object is displayed in order to select the object, or move the touch contact across the surface in order to move the object. Similarly a touch contact may be used to draw or annotate on the display of the touch surface.

Various applications for such touch sensitive surfaces are well-known in the art, such as in handheld electronic devices such as mobile phones or personal data assistants (PDAs). On a larger scale, such touch surfaces are also known as part of interactive display systems, such as electronic whiteboards. More recently, touch sensitive display surfaces have been shown as being used for interactive tables, where the display surface is disposed in a horizontal plane as a table surface.

It is also known in the art of touch sensitive display surfaces to include such surfaces in a collaborative input system, to allow for multiple users to interact with the touch sensitive display simultaneously. In practice multiple inputs can be received from a single user, as well as from a plurality of users. The interactive touch sensitive surface is adapted to be responsive to touch inputs in general, and thus is responsive to a plurality of touch inputs.

One problem with such systems is that there is no way for the system to comprehensively distinguish between different types of touch input.

It would be possible to distinguish between different types of touch input based on the shape of the contact surface with the interactive touch surface. For example, a touch sensitive surface may be adapted to distinguish between a fingertip contact with the surface and a “palm of the hand” contact with the surface, based on the surface area of the contact point. Similarly a touch sensitive interactive surface may be adapted to detect the shape of other objects placed on the surface. However there is no mechanism for an interactive touch sensitive surface to distinguish between touch inputs, based on inputs detected at the interactive surface, other than by the use of distinguishing shape. Where multiple touch inputs are provided by the same input type, for example finger touch inputs, no mechanism exists for distinguishing between such inputs at the interactive surface.

In multi-input scenarios, it may be beneficial in implementations to be able to distinguish between the inputs provided by different users.

It is therefore an aim of the present invention to provide an arrangement for a touch sensitive surface which allows for inputs from different users to be distinguished.

In general, it is an aim of the present invention to provide an improved user interface for a collaborative input system incorporating a touch sensitive surface.

### SUMMARY OF THE INVENTION

In one aspect the invention provide a method of collaborative working at a touch sensitive surface of a collaborative input system, the method comprising: selecting, by touch, at the touch sensitive surface, a displayed icon; providing further inputs, by touch, at the touch sensitive surface, wherein the further inputs are associated with the selected icon.

The further inputs may be associated with the selected icon until a different icon is selected.

The further inputs may be associated with the selected icon until the selected icon is deselected.

The method may further comprise the step, upon selection of the displayed icon, of associating the displayed icon with a user. The method may further include the step of a user registration process on selection of the displayed icon to identify the user.

The step of selecting a displayed icon may comprise selecting the icon and dragging the icon to an edge of the touch sensitive surface. Responsive to detection of an icon dragged to the edge of the touch sensitive surface, the icon may be selected.

Upon selection a selected icon may be oriented with respect to an edge of the touch sensitive surface. The selected icon may be orientated with respect to the edge to which it is dragged.

On selection the icon may be positioned at a predetermined distance from an edge of the touch sensitive surface.

Upon selection of the displayed icon a plurality of identification options may be provided for selection. The options may include a plurality of avatars or a plurality of images. The selection of a further displayed icon may confirm a user selection of the options. When there is selected a plurality of icons by a plurality of users, a user selection process may be maintained until all users have confirmed the selection of any options for each of the plurality of selected icons.

The method may further comprise repositioning the displayed and selected icon on the touch sensitive surface.

A plurality of users may select a plurality of displayed icons. Two or more of the plurality of selected icons may be grouped. The grouping may be denoted by a displayed identifier on the grouped user icons. The grouping of the user icons may be determined by a user selecting a group identifier for their displayed icon.

A selected user icon is deselected by dragging the displayed icon away from the edge of the touch sensitive surface.

The method may further comprise the step of defining at least one active area on the touch sensitive surface, wherein the active area is reserved for use by one or more users.

The method may further comprise the step of defining at least one active area on the touch sensitive surface, wherein the active area is reserved for use by one or more applications.

The method may further comprise the step of defining a plurality of active areas on the touch sensitive surface, wherein the active areas are defined by the selection of user icons.

Each selected icon may be associated with a menu. The menu may be displayed by selecting the icon.

The method may further comprise the step of determining a position of a user associated with the displayed icon. The position of the user may be determined by the position of the displayed icon.

The method may further comprise providing a plurality of displayed icons, each displayed icon being for association with a particular identity. The identity may be a user identity.

The method may further comprise selecting an option displayed following a selection of the displayed icon, and associating the selected option with that icon. The option is a tool selected from a tool menu, the tool being displayed on the touch sensitive surface, wherein any inputs derived from use of the tool are associated with the displayed icon.

The displayed icon may represent a database.

The method of collaborative working at a touch sensitive surface may further comprise: locating the position of a plurality of users relative to the touch sensitive surface in dependence on the location of a respective plurality of displayed icons associated with the plurality of users; and associating inputs at the touch sensitive surface with a specific user in dependence on the location of an input being proximate the located position of the user. An input may be determined to be proximate a located position of a user if it is within a certain area about the located position of the user. The step of locating a position of a plurality of users may comprise determining the position of the users relative to the edges of the touch sensitive surface. The method may further comprise the step of determining the number of users. The method may further comprise the step of tracking the inputs from each user. The method may further comprise providing information on the contribution made by each user. A system action may be determined by a collective response from all users.

The method may further comprise associating with the displayed icon any function co-located therewith. A function may be associated with the displayed icon if a further displayed icon representing such function is positioned coincident with the displayed icon.

The method may further comprise providing a plurality of displayed icons, each associated with one of a plurality of users, wherein two or more displayed icons are associated with a grouping. A common grouping among two or more displayed icons is denoted by a common element of the displayed icons. There is provided one or more predetermined groups, and further wherein an association of a displayed icon with a grouping comprises associating the displayed icon with a predetermined group. Inputs associated with a displayed icon associated with a grouping are tracked to determine the contribution of an individual to a group.

The method may further comprise providing a plurality of displayed icons, each for associating with one of a plurality of users, wherein an operation of an application running on a computer system associated with the touch sensitive surface is dependent upon an input associated with each of the plurality of icons. The operation of the application may be dependent on each of the plurality of displayed icons being associated with a user.

The displayed icon may be associated with a user, wherein a current position of the displayed icon represents the current position of the user relative to the touch sensitive surface. The position of the user is determined in dependence on the displayed icon being located at or near an edge of the touch sensitive surface.

The method may further comprise a plurality of displayed icons, each associated with one of a plurality of users, wherein the touch screen display surface is formed of at least one work area being a subset of the whole area, wherein inputs detected in such work area are associated with a user in dependence on the displayed icon associated with said user being located in the work area.

The method may further comprise selecting a tool or object associated with the displayed icon, wherein any interaction with the tool or object is associated with the displayed icon. The displayed icon may be associated with a user, and the interaction with the tool or object is associated with the user. The tool or object may be selected through an association with or selection of the displayed icon.

In one aspect the invention provides a method of collaborative working at a touch sensitive surface, comprising: determining the position, relative to the surface, of a plurality of users; and allocating inputs to one or more users in dependence on the determined positions, based on the location of the input relative to the determined positions.

The method may further comprise tracking the contribution of each user. The method may further comprise tracking the contribution of each user in a collaborative task. The position of the user may be determined in dependence on the position of a displayed icon associated with the user. The displayed icon is positioned by the user. The displayed icon is positioned along an edge of the touch sensitive surface.

In one aspect the invention provides a method of collaborative working at a touch sensitive surface, comprising: defining an area associated with a user; and associating any displayed information in said area with said user.

The area may be defined by a physical area of the touch sensitive surface.

The area may be defined by a graphical icon displayed on the touch sensitive surface.

The step of associating may comprise selecting and dragging displayed content into the defined area.

In one aspect the invention provides a method of collaborative working at a touch sensitive surface, comprising: associating each of a plurality of users with a group; and tracking group inputs.

The step of associating each of a plurality of users with a group may comprise each user joining a group.

The method may further comprise providing a plurality of user groups.

The group may be defined by an application, and the association of a user with a group comprises the user joining the defined group.

In one aspect the invention provides a method of collaborative working on a touch sensitive interactive display surface, comprising displaying a plurality of user interface elements each associated with one of a plurality of users, wherein an operation of an application running on a computer system associated with the touch sensitive interactive display is dependent on a selection made by each user at the respective user interface element.

The operation of an application running on a computer system associated with the touch sensitive interactive display may be dependent on the selection made by each user at the respective user interface element being the same selection.

The selection made by each user may comprise a selection of a user identity.

In one aspect the invention provides a method of tracking the position of a user relative to the edge of a surface of a touch sensitive interactive display surface, comprising providing for each user a user icon displayed on the display surface, wherein the current position of the displayed user icon represents the current position of the user.

The movement of the user icon for a user may represent the movement of the position of a user.

An input detected in an area proximate the user icon may be associated with the user associated with the user icon.

In one aspect the invention provides a method of collaborative working in a system comprising a touch screen interactive display surface, comprising providing a plurality of user icons representing a respective plurality of users; dividing the touch screen interactive display surface into a plurality of work areas, wherein each work area is arranged to receive inputs from one or more specified users, the users being specified by the location of their associated user icon in association with the work area.

The work areas may be defined by proximity to portions of edges of the interactive display surface.

The invention provides a computer program for performing any of the above-stated method steps.

The invention provides a computer program product for storing computer program code for performing any of the above-stated method steps.

In additional aspects, the invention provides a collaborative input system adapted to perform any one of the above-stated method steps.

### BRIEF DESCRIPTION OF THE FIGURES

The invention will now be described by way of example with reference to the accompanying figures, in which:

FIG. 1 illustrates the selection of a user token in accordance with one embodiment of the invention;

FIG. 2 illustrates a process in selection of a user token in accordance with an embodiment of the invention;

FIG. 3 illustrates orientation of a user token in accordance with an embodiment of the invention;

FIG. 4 illustrates registration of a user token in accordance with an embodiment of the invention;

FIG. 5 illustrates association of a user token in accordance with an embodiment of the invention;

FIG. 6 illustrates tracking of user inputs in accordance with an embodiment of the invention;

FIG. 7 illustrates a process for tracking user inputs in accordance with an embodiment of the invention;

FIG. 8 illustrates selection of user tokens in accordance with embodiments of the invention;

FIG. 9 illustrates user registration of tokens in an initialisation/registration process in accordance with an embodiment of the invention;

FIG. 10 illustrates association of tools with user tokens in accordance with embodiments of the invention;

FIG. 11 illustrates association of a game with user tokens in an embodiment of the invention; and

FIG. 12 illustrates association of images for editing to user tokens in accordance with an embodiment of the invention.

### DESCRIPTION OF THE PREFERRED EMBODIMENTS

The invention is now described by way of reference to various examples, embodiments, and advantageous applications. One skilled in the art will appreciate that the invention is not limited to the details of any described example, embodiment or detail. In particular the invention may be described with reference to exemplary interactive display systems. One skilled in the art will appreciate that the principles of the invention are not limited to any such described systems.

The invention is described herein with reference to a touch sensitive interactive display surface for collaborative working. The invention is particularly described in the context of such a surface provided as a horizontal—or ‘table-top’—surface, but is not limited to such a specific user arrangement.

The invention is not limited to any particular type of touch sensitive technology, nor to any particular type of display technology. In examples, the display of the touch sensitive surface may be provided by a projector projecting images onto the touch sensitive surface. In other examples the display may be provided by the touch sensitive surface being an emissive surface. Various other options exist as will be understood by one skilled in the art. In general the surface 100 is described herein as a touch sensitive surface, which may have images projected thereon (e.g. by a projector) or which may also be an emissive display surface.

An arrangement of the invention provides a method of providing an input at a touch sensitive surface of a collaborative input system, comprising selecting, by touch, at the touch sensitive surface, a displayed icon, and providing further inputs, by touch, at the touch sensitive surface, wherein the further inputs are associated with the selected icon. A collaborative input system is, as known in the art, a system in which multiple users provide inputs to the system. The collaborative input system provides a multi-user workspace.

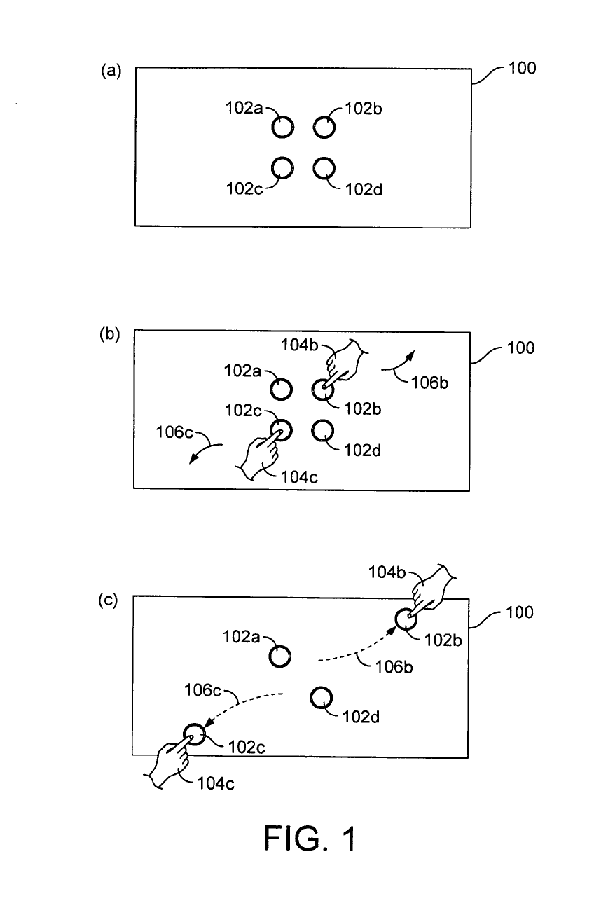

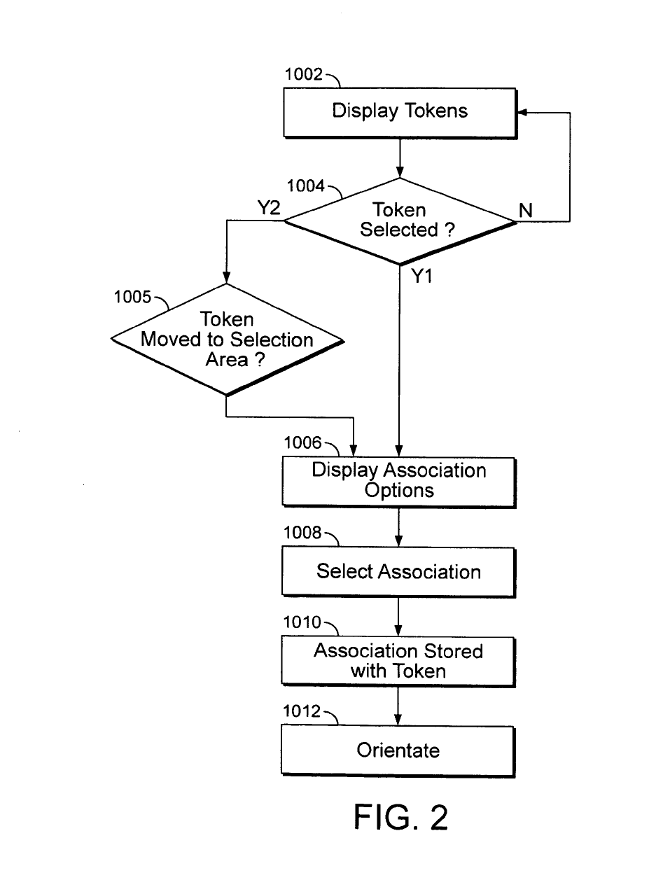

The operation of a first exemplary arrangement in accordance with the invention is described with reference to FIG. 1 and FIG. 2.

With reference to FIG. 1(a), there is generally illustrated by reference numeral 100 a touch sensitive interactive display surface. The surface 100 constitutes a touch sensitive area, with which there is an associated display.

As illustrated in the example of FIG. 1(a), four graphical user interface (GUI) icons, or displayed icons, are displayed on the display of the touch sensitive surface 100. These icons are denoted by reference numerals 102a to 102d. In a preferred embodiment the icons may also be referred to as tokens. The term tokens is used in this description.

As denoted in FIG. 2, the step 1002 denotes the display of a plurality of tokens. The tokens may be displayed anywhere on the display, and the arrangement of FIG. 1(a) is merely illustrative. In general there may be two or more tokens displayed on the touch sensitive interactive display surface.

The icons 102a to 102d displayed on the touch sensitive surface represent tokens which may be selected and given an association, as described further hereinbelow. For example, a token may be associated with a user.

For the purposes of describing embodiments, it is assumed that the touch sensitive surface 100 is disposed as a horizontal surface, forming a “tabletop” interactive surface. Users may therefore stand around the surface, and be located at any of the four edges of the surface. In different embodiments the surface may be of a shape other than the rectangular shape illustrated in the Figures.

As illustrated in the example of FIG. 1(b), two tokens are selected. A user may select a token 102c using their hand 104c, selecting the token with a finger. Similarly a user may select the token 102b, using their hand 104b, the token being selected with a finger.

The selection of tokens is illustrated in FIG. 2 by step 1004. If no token is selected in step 1004 then the tokens continue to be displayed. If a token is selected, then in a first arrangement an association is formed in steps 1006 and 1008.

In a step 1006 association options for the selected token are displayed or presented. The association options may vary according to an application or implementation. In general, the association provides for an identity to be associated with a token. Examples of association options are given further in the following description. For the purposes of this example, an association is established between a token and a user.

Thus the options that are displayed in step 1006 in this example are user identification options. The options may be displayed as a list of registered users, or as an option to create a user. The option to create a user may include the option to create a user account to formally identify a user. The option to create a user may include the option to create a user identity, by selecting an avatar for example, such that a user identity is created without any verification of the user identity—effectively a unique anonymous user.

In a step 1008, the user selects the appropriate association, in this case a user identity. Thereafter, in a step 1010, the selected association with the token is stored.

Following determination of selection of a token in step 1004, in a second arrangement rather than going to step 1006 directly the process moves on to step 1005. The step of displaying the association options in step 1006 is only enabled after a token is selected and moved, in particular after the token is determined as being moved to an area of the touch sensitive display surface which triggers a selection for association. This optional step 1005, which is implemented between steps 1004 and 1006, is now further described with reference to FIGS. 1(b) and 1(c). In this arrangement, in step 1004 it is determined whether a token has been selected by virtue of a contact, and then in step 1005 it is determined if that contact—or initial selection—is a selection for the purposes of defining an association.

As illustrated by arrows 106c and 106b in FIG. 1(b), in contact with the token 102c the hand 104c is moved by the user in the direction of the arrow 106c towards one side or edge of the touch sensitive surface 100. Similarly the hand 104b, in contact with the token 102b, is moved by the user in the direction of the arrow 106b towards another side or edge of the touch sensitive surface 100. In order to move any one of the tokens 102, the touch contact is retained as the hand is moved towards the edge of the touch sensitive surface 100, i.e. the finger must remain in contact with the display surface.

As illustrated in FIG. 1(c), the token 102c is moved to one edge of the touch sensitive surface by the hand 104c, and the token 102b is moved to another edge of the touch sensitive surface 100 by the hand 104b.

In accordance with the optional step 1005, the detection of a token being moved and positioned in a location proximate an edge of the touch sensitive surface triggers selection of that token, and triggers the steps to define an association. The association options are then displayed in step 1006. Steps 1008 and 1010 then follow as described previously.

In this example arrangement, as discussed above with reference to step 1005, a token may be considered to have been selected for allocation of an association, e.g. to a user, only when it is moved to within a certain distance of an edge of the touch sensitive surface 100. In one arrangement a border may be displayed around the edge of the display of the touch sensitive surface 100, and once a token 102 is moved within the displayed border it may be considered as having been reserved or selected for an association, e.g. with a user. Such a border may be temporarily displayed during a set-up initialisation, or registration process. The selection may be triggered by the detection of the touch contact with the token being released or removed with the token being within a certain location or distance of an edge of the display. The position may require the displayed token to abut the edge of the display area.

Thus, in the above described exemplary arrangement the dragging of a token to an edge of the display surface denotes a selection of that token for the purposes of defining an association.

FIGS. 1(a) to 1(c) represent an exemplary initial operation, such as an initialisation process, registration process, or set-up process, in a touch sensitive surface application, where users select tokens to define a user association. In one example arrangement a user association may be defined simply following selection of a displayed token by touch. In another example arrangement a user association may be defined only after the token is selected by touch and then located in a particular area of the display surface. Other types of association may be similarly defined, independent of or in combination with a user identity association. Two users have respectively selected tokens 102c and 102b.

On selection, a token may be orientated in a particular arrangement. For example, the token may be orientated, in the example above, with respect to the edge of the display to which it is dragged. The orientating of a token comprises orientating such that information displayed in or with a token is displayed optimally. Text such as a user name or alias, or an image such as an avatar or photograph, is optimally positioned by orientating the token with respect to the edge of the display. This preferably comprises orientating the token such that the content is aligned with an edge, e.g. so a user standing at that edge can view it optimally. The orientation preferably takes place after the token is positioned in the edge region, and/or before or after association.

In FIG. 2 this optional orientation is shown as taking place in a step 1012, after association is complete, as this provides the content to be orientated. However orientation may be carried out as soon as the selection of token is detected, such as when it is detected that a token has been dragged toward a position at or near the edge of the display surface, and then released.

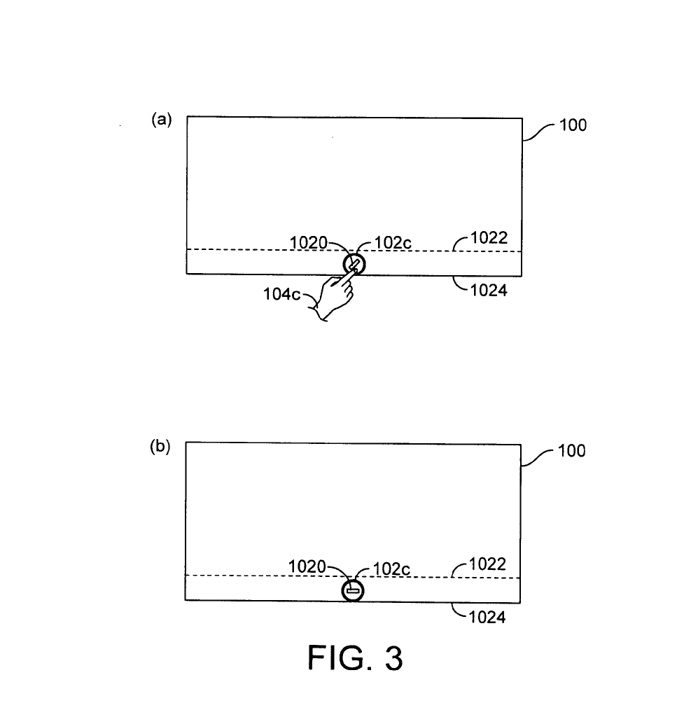

FIG. 3 illustrates an example of orientation. As shown in FIG. 3(a), the token 102c is located in an area at or near an edge 1024 of the touch sensitive display surface, within a border region nominally defined by an area between the edge of the display 1024 and a line 1022 across the display surface parallel to the edge of the display. Also illustrated in FIG. 3(a) is the hand 104c with which the token 102c is dragged into the border region.

Also illustrated in FIG. 3(a) is content 1020 of the token 102c, such as display information displayed within the token 102c. In most expected scenarios the association for the token will not yet be defined. The token may simply display a label, such as “Token”. Alternatively the token may display no information, but it will nevertheless be orientated such that when information is displayed it is correctly orientated. As illustrated in FIG. 3(a), on initial positioning this content 1020 is not correctly orientated to the edge 1024. The orientation on initial positioning may be random. Following removal of the touch contact provided by the hand 104c on the token 102c, as illustrated in FIG. 3(b) the token 102c is orientated such that the content 1020, or the position where content can be displayed, is aligned with the edge 1024. In the preferred arrangement, the orientation is based on the assumption that a user viewing the content is positioned at the edge adjacent to where the token is positioned. In other arrangements the optimal or preferred orientation may differ.

Further, in an arrangement, once a token is dragged to the edge of the display, and optionally orientated in a preferred position, it may be further positioned, once selected, a predetermined distance from an edge of the display. A fixed distance may be set between the edge of the surface and the perimeter of the token nearest to the edge.

The mode of operation illustrated with respect to FIGS. 1(a) to 1(c) and FIG. 2 may be an automatic mode which is entered during an initialisation of a system or start-up of an application, or may be a mode of operation which is selected by a user from a menu option. It will be understood that additional images or graphic displays may be displayed on the touch sensitive surface whilst the operation described in FIGS. 1(a) to 1(c) and FIG. 2 is being performed in a token-selection mode of operation.

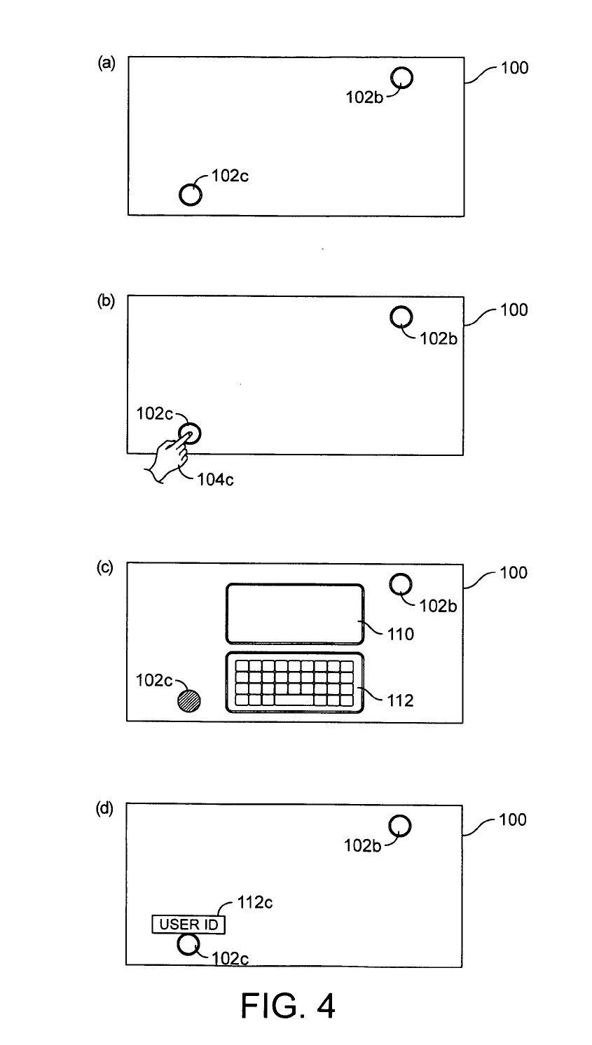

With reference to FIGS. 4(a) to 4(d), there is illustrated a further exemplary arrangement in which an association of a token with a user is defined.

As illustrated in FIG. 4(a), the tokens 102c and 102b have each been positioned toward the edge of the touch sensitive display surface 100.

As illustrated in FIG. 4(b), the user associated with the hand 104c selects the token 102c, such that the token 102c preferably becomes highlighted. The token 102c may also be considered at this point to be active.

In this described arrangement the token 102c is, at this stage, not associated with a specific user. Although a user has selected the token and dragged it to the edge of the touch sensitive surface, there is no relationship defined between the token and a particular user.

In this mode of operation, following selection of the token 102c by the hand 104c, the token 102c becomes highlighted, and the display on the touch sensitive display surface is further adapted to display a virtual keyboard 112 and a display area 110. The virtual keyboard 112 and the display area 110 may then be used in order to allow the user selecting the token 102c to input further details to identify themselves. The display 110 may present fields to allow a user to log into a registration system, or to allow a user to otherwise identify themselves by entering a name or other identification information. Following an appropriate registration or other procedure, the token 102c is modified as illustrated in FIG. 4(d) to include a user ID as denoted by reference numeral 112c. The user ID may be the identity of a user known through a registration system, or a temporary ID given by a user to customise the token 102c.

This user identification process does not necessitate that the token is located at the edge of the display. This association of the user may take place regardless of the location of the token.

The selection of a token in any arrangement need not necessarily require the token to be dragged to the edge of the display, nor held in a fixed position at the edge of the display. For example, a user may simply touch a token and then make one or more further touch inputs, and the one or more further touch inputs are then associated with that token.

In the above example, the process of providing a user identity is performed as a distinct operation, when a user selects the token with a touch after the token has been positioned in an area for token selection. In alternative, and preferable, arrangements the request for a user identity to be associated with the token—or in embodiments some other form of identity—may be prompted automatically once the token is selected for an association. Thus, in the example of FIG. 4, the keyboard 112 and display area may be displayed immediately the user removes finger contact with the token after dragging it to the edge of the display area.

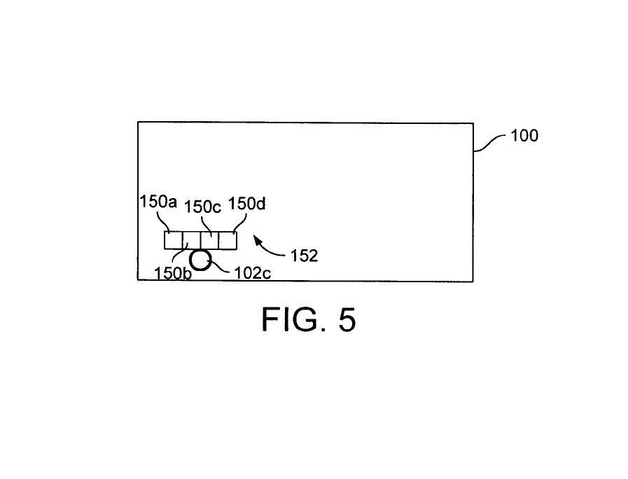

Other techniques for providing a user association may be provided. In FIG. 5 there is illustrated an arrangement in which a set 152 of user identification options 150a to 150d are displayed after selection of a token for a user association. The options 150a to 150d could identify registered users of the system, e.g. by names or by photograph, such that a user may select their own identity. Selection of a user identity in this way may require confirmation by entering a password. The options 150a to 150d could identify avatars, such that a user may select an anonymous identity. The number of user identification options displayed may represent all options, or only a small number of available options, additional options being displayed by searching the displayed set 152 left or right.

Thus a plurality of identification options may be provided for selection. These options may include selection from amongst a plurality of avatars or a plurality of images etc. These options may allow for a user to be identified anonymously.

Thus the selection of a further displayed icon after selection of a token, for example the selection of an identity for the user such as selection of one of the options 150a to 150d in FIG. 5, may confirm the user's selection of the user identification options.

The above describes examples where a selected token is associated with a user. However the association defined is not required to be a user association. Another type of association may be assigned independent of, or in addition to, a user identifier. For example, a token may be associated with a group identity rather than a user identity. Referring again to FIG. 5, there may be displayed a set 152 of group identification options 150a to 150d. The group identification options 150a to 150d may each identify predefined groups, and the user may select a predefined group from the options to join that group. The groups may simply be presented as colour options, or with some other form of group identifier. In this way the user can choose to associate a token with a group, which is an example of providing an association for a token other than to a specific user.

Thus selected icons or tokens may be grouped regardless of whether they are associated with a user. The association of a token with a group may be denoted by a displayed identifier on the token. For example, a token may be displayed in a particular colour, or at least in part with a particular colour, to denote association with a group. All tokens associated with a common group may be displayed with the same colour or appropriate displayed indication.

The grouping may be determined by a user selecting a group identifier for their displayed icon as mentioned above with respect to FIG. 5.

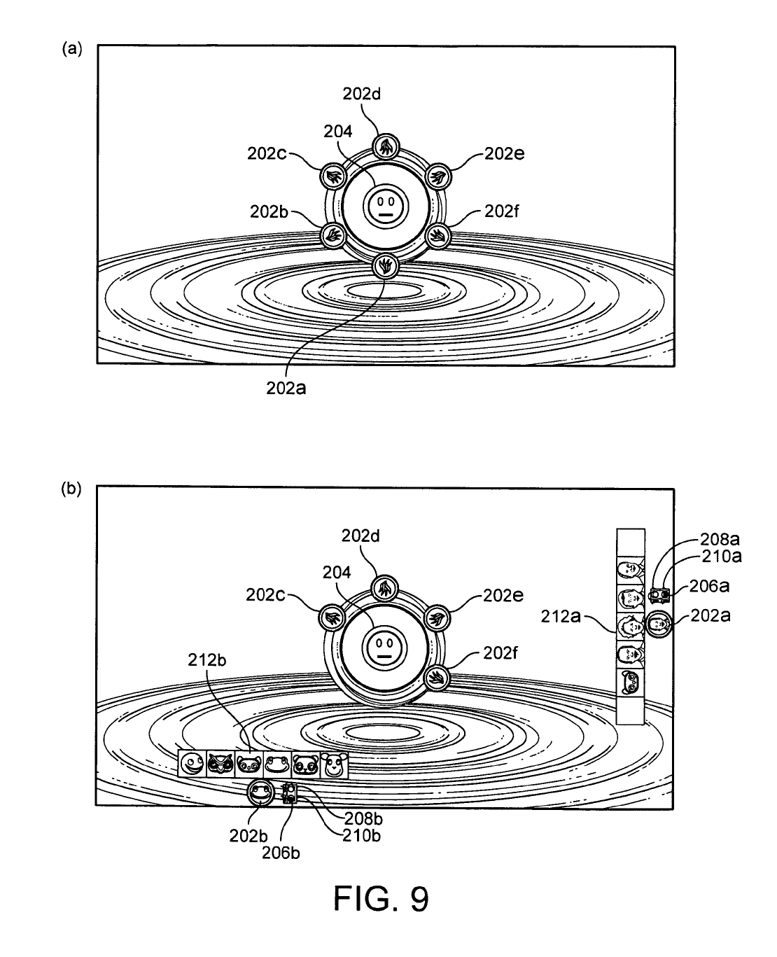

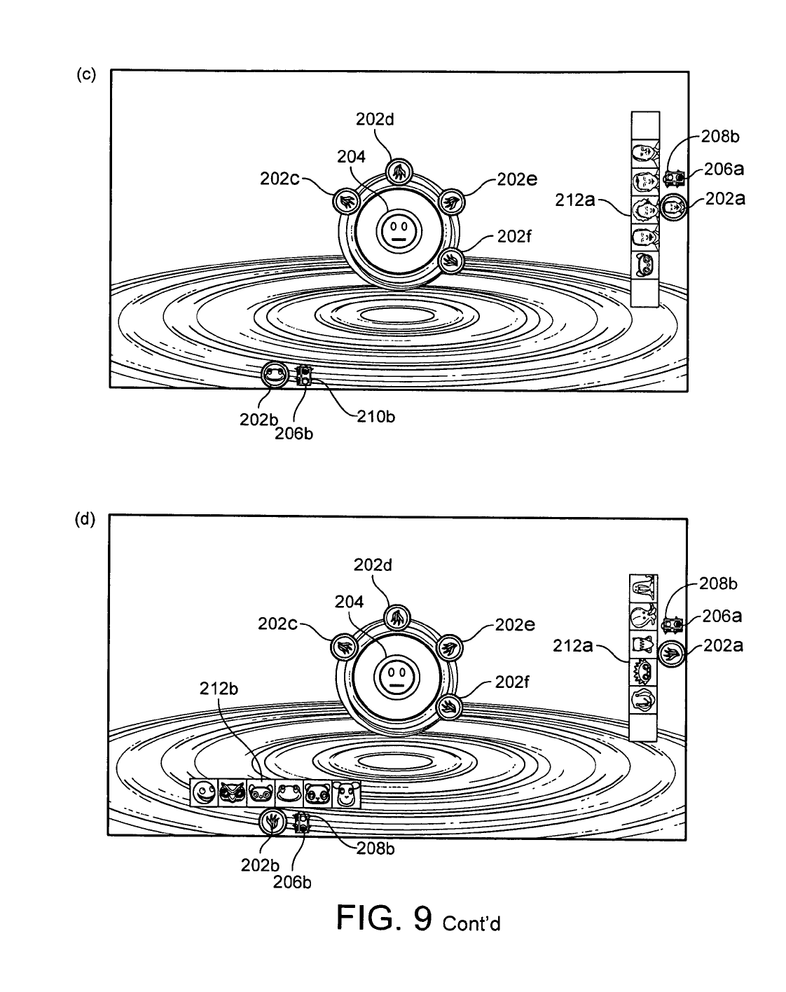

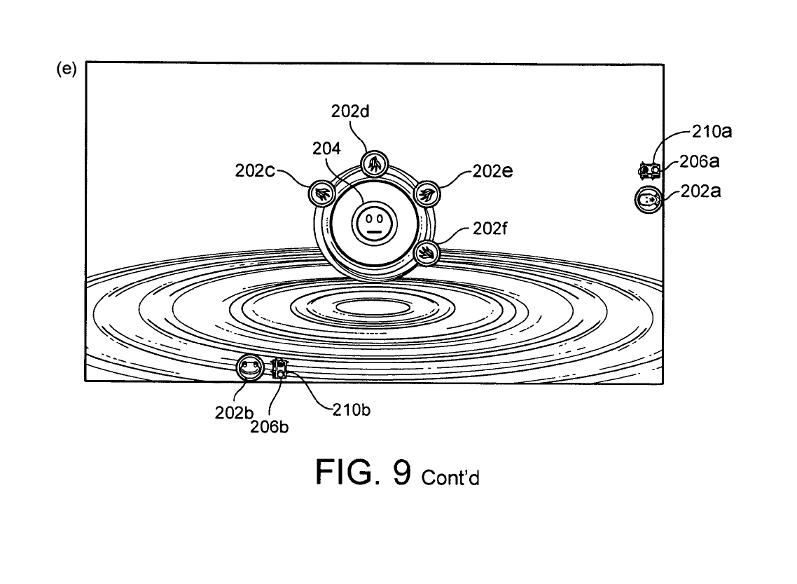

A user selection or initialisation process may not be completed until options for each of a plurality of selected icons, such as user identity options, are confirmed. For example, the user registration process may be maintained until a user association has been defined for each selected token. In general, there may be a requirement for a suitable association (user or otherwise) to be defined for each token before an initialisation or registration process is completed. The initialisation or registration process may be associated with a specific application, the application only proceeding once a registration or initialisation is complete. A specific example of enabling an application to proceed only once all selected tokens have been associated with a user is described further in an exemplary description below with reference to FIG. 9.

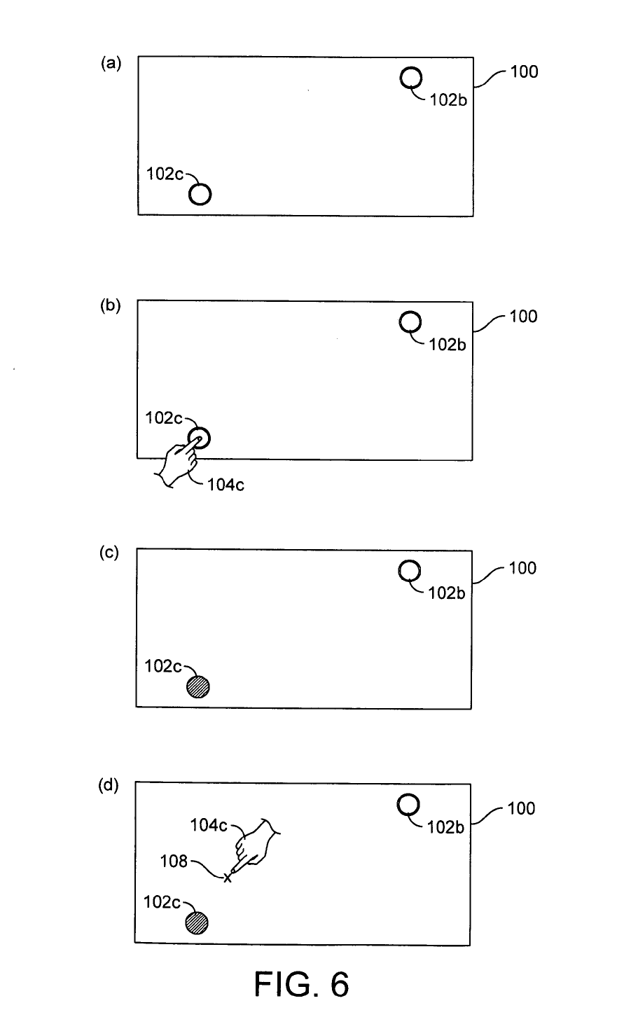

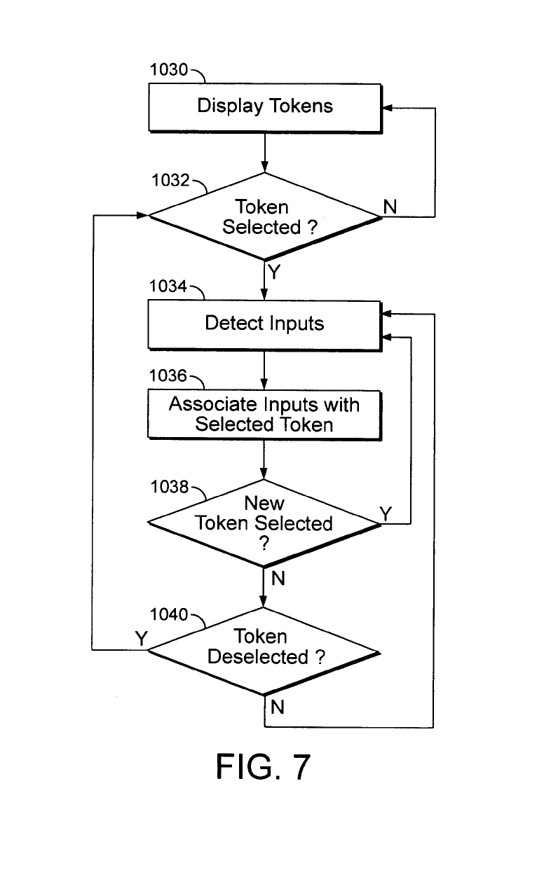

With reference to FIGS. 6(a) to 6(d) and FIG. 7, there is illustrated the use of the selection and user association of the tokens as described above to identify touch inputs provided by a user as being associated with a particular user after a token has been associated with a user, in an exemplary arrangement. In this described arrangement, it is assumed that a token has been dragged to an edge to be selected for an association. Following such selection, a user association has been selected for the token. This is consistent with the arrangements described above. Various exemplary arrangements are described herein in the content of such a described process to select and associate a token, but it will be understood that alternative methods for selecting a token may be implemented.

As illustrated in FIG. 6(a), a user has selected a token 102c and a further user has selected a token 102b, the selection being achieved by dragging the respective tokens to edges of the surface, and associating the token with a respective user identity. Thus the initial operation is complete, with user identities allocated. As denoted by step 1030 of FIG. 7, the tokens are displayed on the surface.

As illustrated in FIG. 6(b), one user uses their hand 104c to select the token 102c. This selection is detected in a step 1032.

As illustrated in FIG. 6(c), following this selection the token 102c may be highlighted, or in some way its appearance is modified, to illustrate its selection. Alternatively, no modification or highlighting of the token 102c may take place. However the preferable highlighting or modification of the displayed icon for the token 102c illustrates that this token has currently been selected and may be advantageous.

Following selection of the token 102c in step 1032, as illustrated in FIG. 6(d) the user associated with the hand 104c may then carry out touch operations on the surface 100. As illustrated in FIG. 6(d) the finger contact point of the user's hand 104c at the touch sensitive surface 100 is associated with a cursor denoted by reference numeral 108, which may be moved around the surface by movement of the finger. As one skilled in the art understands, the touch inputs provided by the user associated with the hand 104c may be generally used to select displayed images, manipulate displayed images, provide inputs such as annotations and drawings etc. The user's finger contact may be generally used to interact with applications, open and close applications, select and manipulate tools etc. As denoted by step 1034 in FIG. 7, these inputs are detected, and processed, by the system in the usual way as known in the art.

In accordance with this preferred arrangement, all touch inputs detected by the touch sensitive surface 100 following selection of the token 102c are associated with the token 102c as denoted by step 1036 of FIG. 7. All touch inputs are associated with the token 102c until the token 102c is deselected in a further operation, or until it is superseded by selection of a different token.

A selected token may be deselected simply by touching it, or selecting it, again following an initial selection.

In step 1038 of FIG. 7, it is determined whether a new token has been selected. If it has, then steps 1034 and 1036 are repeated, but with the inputs being associated with the newly selected token.

If no new token has been selected, then in a step 1040 it is determined if the current token has been deselected. If the token has not been deselected then steps 1034 and 1036 are repeated with the inputs continuing to be associated with the current token. If the current token is deselected, then in step 1030 the method returns to await selection of another token in step 1032.

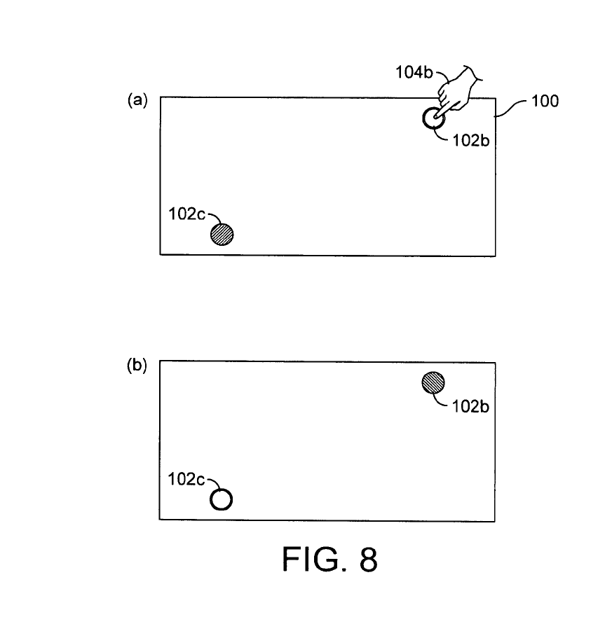

With reference to FIGS. 8(a) to 8(b), there is illustrated the process by which touch inputs may be associated with a different user input.

As illustrated in FIG. 8(a), the token 102c is highlighted, indicating selection of that token. A finger of the hand 104b associated with a further user then touches the token 102b. As illustrated in FIG. 8(b), thereafter the token 102c is no longer highlighted, and the token 102b is highlighted. All touch inputs detected after selection of the token 102b are then associated with the token 102b. This is represented in the flow process of FIG. 7 by step 1038.

Touch inputs detected when no token has been selected may, in certain arrangements, be ignored. That is a touch input may only be processed if it can be associated with a token. In other arrangements a touch input may still be processed even if a token is not selected, such inputs then not being able to be associated with any token.

As discussed further hereinbelow, each selected token may be associated with a menu. The menu may be displayed by selecting the token. The menu may allow, for example, the user to join a new group, or otherwise change settings associated with the token.

In operation of an application or operating system, user interface tools may be allocated to a user if they originate from a token associated with a user. For example, if a toolbox is presented on selection of a user token, and from that toolbox a particular tool is selected, then all use of that tool—and all inputs associated with the use of that tool—are associated with that token and consequently that user. An example is where a user selects a keyboard from a menu, and a virtual keyboard is then displayed somewhere on the surface. All inputs made with the virtual keyboard are then associated with the user. An example is given above with respect to FIG. 4 where such a keyboard is associated with a token during user registration, however more generally such an association may be created on any use of an application.

A token does not need to be associated with a user. A token provides an anchor point with which inputs can be associated, and may or may not be linked or associated with a specific user. For example, in an alternative, rather than being associated with a user, a token may be associated with a database. If the token is selected, any inputs then further detected are recorded in the database.

In a further arrangement there is provided a method of collaborative working at a touch sensitive surface, comprising determining the position, relative to the surface, of a plurality of users; and allocating inputs to one or more users in dependence on the determined positions, based on the location of the input relative to the determined positions.

The position of the plurality of users relative to the surface can be determined based on the location of a token associated with a user. For example, referring to FIGS. 8(a) and 8(b), it can be assumed that a user associated with the token 102b is positioned proximate to the edge of the surface where the token 102b is located, and similarly the user associated with the token 102c is positioned proximate the edge of the surface where the token 102c is located. Any inputs which are detected at the surface in a region proximate to either of the tokens 102b and 102c is therefore associated with the respective user. Thus an area may be defined around or in association with a token, and any inputs associated with that area allocated to the user associated with the token. Thus an input is determined to be proximate a located position of a user if it is within a certain area about the located position of the user, the position of the user preferably being determined by the position of the token associated with the user.

As will be understood from the foregoing description, a plurality of tokens may be associated with a respective plurality of users, such that inputs from a plurality of users may be tracked. Thus in a collaborative working environment, the system may track all inputs provided, and additionally track the users providing such inputs. Thus the contribution of each user in a collaborative task may be determined.

As will be understood from the foregoing, the determination of which user an input is received from may be determined in a number of ways. This may be determined based upon the token that was selected before the input was entered. This may be based upon the area of the work surface within which the input was entered. As described above the area may be determined based on a determination of the location of the user. Alternatively, and as will be discussed further hereinbelow, there may be areas of the work surface which are defined or reserved for use by particular users, such that any inputs in those areas are determined to be from a particular user.

As will be understood from the foregoing, a token associated with the user may be moved around the work surface to be displayed in different positions, by selecting the token with touch and dragging it about the work surface. In this way a user may move the token with which they are associated as they move position around the table to, for example, dynamically adjust a work surface area of the surface with which they are associated.

The work surface area of the touch sensitive display may be divided in accordance with the number of users and the associated number of tokens. For an example if two tokens have been selected and associated with users, and the tokens are positioned on opposite edges of the work surface, then the work surface may be divided in half down the middle, with each half being associated to the respective user, such that any inputs in the respective halves are associated with those respective users.

Thus, in an exemplary arrangement, a method of collaborative working at a touch sensitive surface comprises locating a position of a plurality of users relative to the touch sensitive surface in dependence on the location of a respective plurality of displayed tokens associated with the plurality of users, and associating inputs of the touch sensitive surface with a specific user in dependence on the location of an input being proximate the located position of the user.

In this arrangement the method may include determining the number of users.

In a further arrangement a GUI icon comprising a token may be formatted and displayed in such a manner that other GUI icons may be overlaid. Such a token may be considered a container, within which additional GUI icons may be placed or contained. Any GUI icon which is placed or contained within the token is associated with that token and therefore associated with any identifier associated with that token, such as a user identifier.

In an alternative to this arrangement, the container associated with the token may be defined as a specific area of the work surface associated with the token, rather than a displayed icon. Thus, in the example described above where work areas of the touch sensitive display surface are reserved for particular users based on a position of a user's token, that work surface area may be defined as a container, with any GUI icon or object placed within the container being associated with a particular user. Any GUI icon located in or dragged into the specific area or into the container is then defined to have a relationship with that user.

Thus in an arrangement there is provided a method of collaborative working at a touch sensitive surface, comprising: defining an area associated with the user; and associating any displayed information in said area with said user.

As noted above, the area may be defined by a physical area of the touch sensitive surface, or may be defined by a graphical icon displayed on a touch sensitive surface independent of physical area or position.

In arrangements, selecting a GUI icon displayed within the container may result in the display of a menu or tool associated with that GUI icon, which menu or tool may be displayed in an area outside of the container, i.e. outside of the user's reserved work area or outside of the token GUI. That displayed icon is then associated with the user, and any inputs detected at that displayed icon, even if it is outside the area of the user's token or the user's reserved workspace, is associated with the user. Thus any “widget” generated as the result of an interaction with the user's container is automatically associated with the user by its token.

This principle applies to any object or tool generated/displayed from a selection based on a token, for example from a token menu. Any object/tool selected is associated with that token, regardless of its position on the display surface.

In a further example implementation there is provided a method of collaborative working in a system comprising a touch screen interactive display, comprising providing a plurality of user icons representing a respective plurality of users; dividing the touch screen interactive display into a plurality of work areas, wherein each work area is arranged to receive inputs from one or more specified users, the users being specified by the location of their associated user icon in association with the work area.

Thus, as described hereinabove, work areas may be defined on the interactive display surface which represent a sub-area of the overall display surface area. The sub-areas then may be associated with a particular user by associating the area with a token with which that user is associated. These areas may be dynamically defined in dependence upon the current location of a token associated with a user. These areas may be fixed in dependence upon the number of users working in the system and the corresponding associated number of tokens. For example, the system may divide the work area up into a number of equal sized working areas in dependence upon the number of user tokens defined, and then automatically locate the user tokens at the positions which the users need to be located in order to work at the work surface areas they have been allocated.

For example, in an arrangement where two tokens have been associated with users, the system may split the work surface in half (down the middle), and then position each token at opposite edges of the table about the halfway line. Each user then moves to a position at the edge of the table adjacent their token, being able to identify their token by the identification information displayed thereon. Thus in such an arrangement the system determines the best working arrangement for the surface and the users, rather than the users choosing their working position themselves.

Preferably the work areas are defined by proximity to portions of edges of the interactive display surface. Thus work areas may be defined to be of a particular size, such as a size equivalent to a typical work surface area of a personal computing device with a touch sensitive display screen, and an appropriate work area located proximate or coincident with a user's token.

There is preferably provided a plurality of displayed icons, each associated with one of a plurality of users, wherein the touch screen display surface is formed of at least one work area being a subset of the whole area, wherein input detection in such work area is associated with a user in dependence upon the displayed icon with said user being located in, adjacent or proximate to the work area.

In a further arrangement, there is provided a method of collaborative working at a touch sensitive surface, comprising: associating each of a plurality of users with a group; and tracking group inputs.

The association or identifier provided to a token is not necessarily a user identifier. As mentioned hereinabove, the identifier may represent a different association. One example of this is the identification of an association with a group.

For example, during a registration or initialisation process, when a user selects a token the association options which are displayed may include the display of one or more group associations. The user then may select a group association for the token, either in combination with or independent of any other association. In this arrangement, there may be provided one or more predefined groups, or one or more groups may already have been created by other users at the time a new token is selected. Thus a list of one or more available groups is displayed to a user on selecting a token as available association information. The user may select one or more groups, and the token then be associated with such one or more groups.

The association of the token with one or more groups may be indicated on the GUI icon of the token, by displaying a graphical representation representing a group, a name of a group, or for example by displaying the token in a particular colour which colour is associated with a group.

Thus each token may be associated with a group, in addition or independent of being associated with a user identity.

One or more groups may be defined by an application, and thus presented to a user on selection of a token as one or more default groups. The user therefore may join one or more defined user groups.

In a preferable arrangement, inputs associated with tokens which are associated with a common group are tracked to determine the contribution made by individual users to group working.

Thus a token may be associated with a group either with or without user identification, such that inputs may be provided to the group either anonymously or with identification of the user.

In another arrangement, agreement between a plurality of users is required. Thus in a method of collaborative working, collective agreement is required. Collective agreement is provided in the context of multiple inputs being selected on the same user interface.

In an arrangement, a method of collaborative working on a touch sensitive interactive display is provided which comprises: displaying a plurality of user interface elements each associated with one of a plurality of users, wherein an operation of an application running on a computer system associated with a touch sensitive interactive display is dependent on a selection made by each user at the respective user interface element.

Such operation may be dependent upon the selection made by each user being the same selection.

An example of this collective agreement is in the initialisation or registration phase described hereinabove. In an arrangement in which the registration or initialisation phase includes the requirement for a user to select a token by touching and dragging it to the edge of the touch sensitive display surface, which indicates that the user wishes to select the token for an association, the initialisation or registration process may not be terminated, to allow further use of applications, until every such selected token has been associated with the user identity. Thus the selection made by each user may comprise a selection of a user identity, and only once each user has selected a user identity may the initialisation or registration process proceed at the start of an application.

An example could be where an application being enabled is a multi-user game. A number of users select tokens in order to allow them to participate in the game as individual players. The application does not allow the game to commence until each user who has selected a token provides an identity for themselves. Until each selected token has been provided with an identity, the game cannot start.

In other arrangements, the initialisation or registration process may not be completed until another appropriate association has been provided with each token. Thus it may not be required that each user provides an identity for the token. As noted above, it may be required that each token is associated with a group. Thus in alternative arrangements it may be that each token is required to have defined therewith an association with a grouping before the application can proceed to the next stage.

As discussed hereinabove, there is provided arrangements in which the location of a user can be determined in dependence upon the position of a token associated with the user. The user may move around the work surface, and drag their associated token with them. The system thus is able to monitor the movement of a user around the work surface, and adjust accordingly such that inputs are associated with the user in dependence upon the user's current determined location.

Thus an arrangement provides a method of tracking the position of a user relative to the edge of a touch sensitive interactive display surface, comprising providing for each user a user icon displayed on the display surface, wherein the current position of the displayed user icon represents the current position of the user.

The movement of the user icon—or token—for a user represents the movement of the position of a user. An input detected in an area proximate the user icon is associated with the user associated with the user icon.

A user icon associated with an identifier, such as a user identifier, may be de-associated or deselected. In an arrangement in which in order to achieve association of a token the token is dragged to an edge of the display surface, such de-association or deselection may be achieved simply by the user dragging the token away from the edge, toward the centre of the surface, and releasing a touch contact. Following such an action, de-association or deselection may automatically take place. Alternatively the option to de-associate or deselect may be provided from a menu option on selection of the token. Following de-association or deselection the displayed token may be removed from the display, or displayed in a particular portion of the work surface where it is available for selection by a further user.

With reference to FIGS. 9(a) to 9(e) there is illustrated an exemplary registration or initialisation process incorporating features described hereinabove.

As illustrated in FIG. 9, there is illustrated a plurality of tokens denoted by reference numerals 202a to 202f generally disposed on and around a displayed ring 200. A circular icon 204 is displayed within the centre of the ring, which as will be described further hereinbelow gives an indication of the user registration/initialisation process.

In the arrangement of FIG. 9(a), the tokens 202a to 202f do not have any association defined therewith, and are available for selection. One skilled in the art will appreciate that such tokens may be displayed on the display surface in any position.

The circular and central user icon 204 is displayed showing a neutral “face”, indicating that user initialisation/registration has not been completed, and therefore an application associated with the selection of tokens cannot be proceeded with.

As denoted in FIG. 9(b), two users select respective ones of the tokens 202a to 202g. A first user selects the token 202a, and drags the token generally to the right-hand edge (as shown in the Figures) of the display surface. A second user selects the token 202b, and drags the token to the bottom edge (as illustrated by the Figures) of the display.

As illustrated in FIG. 9(b), once the token 202b is dragged to the edge of the display, and preferably appropriately orientated and positioned relative to the edge, an additional icon 206b is displayed adjacent the token 202b, and an additional set of icons 212b are displayed adjacent the token 202b.

The displayed icon 206b is a “traffic light” icon, having two “lights” for display thereon only one of which may be set at any one time. A position 208b denotes a red light, and a position 210b denotes a green light. Whilst the user selection of an identity associated with the token 202b is underway, the traffic light 206b displays a red light 208b. Once the user is satisfied that they have completed their registration, then on touching the displayed icon 206b the displayed light changes from the red light 208b to the green light 210b, meaning that the user has completed their user registration.

Similarly the token 202a is associated with a traffic light 206a, having a red light 208a and a green light 210a, which is controlled in the same manner as the traffic light 206b.

As illustrated further in FIG. 9(b), the set of displayed icons 212b includes a plurality of avatars. As illustrated, the plurality of avatars include, for example, a panda, a frog, a cat, and an owl. The user may scroll through the available avatars by moving their finger left to right on the set of icons 212b, such that more avatars may be available for display than those illustrated in FIG. 9, only a small number being displayed at any one time so as to avoid consuming too much display space on the surface. The user then may select an avatar by touching the avatar with their finger, such that that avatar then appears in the centre of their token 202b. Thus, as illustrated in FIG. 9(b), the user has selected the frog avatar, such that an avatar representing the frog is displayed on the token 202b. In this way, the user may identify themselves anonymously, but in such a way as a unique identity is associated therewith.

As further illustrated in FIG. 9(b), the user associated with the token 202a similarly has displayed a set of user icons 212a, which as illustrated in FIG. 9(b) include the display of photographs of individuals. The user can select the photograph of an individual which represents themselves, and then the appropriate displayed photograph is displayed in the centre of the token 202a. The user may similarly scroll left to right amongst the set of displayed icons 212a, and the photographs of users—which may be registered users of the system—may be displayed as well as avatars and other options for defining an association of the token.

As illustrated in FIG. 9(b), each of the users has selected a displayed icon from their respective sets 212b and 212a, but the traffic light 206b and 206a for each of the users is set at red as denoted by a light in positions 208b and 208a.

As illustrated in FIG. 9(c), the first user completes selection of their user icon, by touching the traffic light icon 206b such that the displayed light turns to the green light in position 210b. The selection options 212b are then no longer displayed, and the selected option displayed in the token 202b, which as illustrated is the avatar of a frog. At the same time, the second user maintains the traffic light 206a in the red light position as denoted by the light in position 208a.

It will be noted that throughout the process of FIGS. 9(b) and 9(c), the displayed “face” of the icon 204 in the centre of the screen is maintained in a neutral position.

With respect to FIG. 9(d), the first user touches the icon 206b again in order to revert their status to incomplete, denoting that a user identification is being selected. Thus the traffic light displayed is the red light in position 208b, and the selection icons 212b are again displayed. As noted in FIG. 9(d) the token 202b is then adjusted such that no user identification is displayed therewith. Similarly for the second user associated with token 202a, the displayed set of icons 212a are altered to show avatars, as the user has scrolled left or right in order to display further options. The user of the traffic light 206a is maintained with the red light in position 208a displayed. The displayed icon 204 is maintained with the “face” in a neutral display.

With regard to FIG. 9(e), there is then illustrated the case where the first user has selected a desired user identity, as denoted by the green traffic light in position 210b of the traffic light 206b. As denoted in FIG. 9(e), this is the selection of a frog avatar in the token 202b. Further the second user associated with token 202a selects the traffic light 206a in order to change the displayed traffic light to the green light in position 210a.

As both users have now indicated that they have completed selection of a user identification, then the display of the icon 204 is changed to a positive display, in order to indicate that all tokens have been associated with users and the users have indicated completion of such selection. As such the initialisation/registration process is complete, and one or more applications may be run.

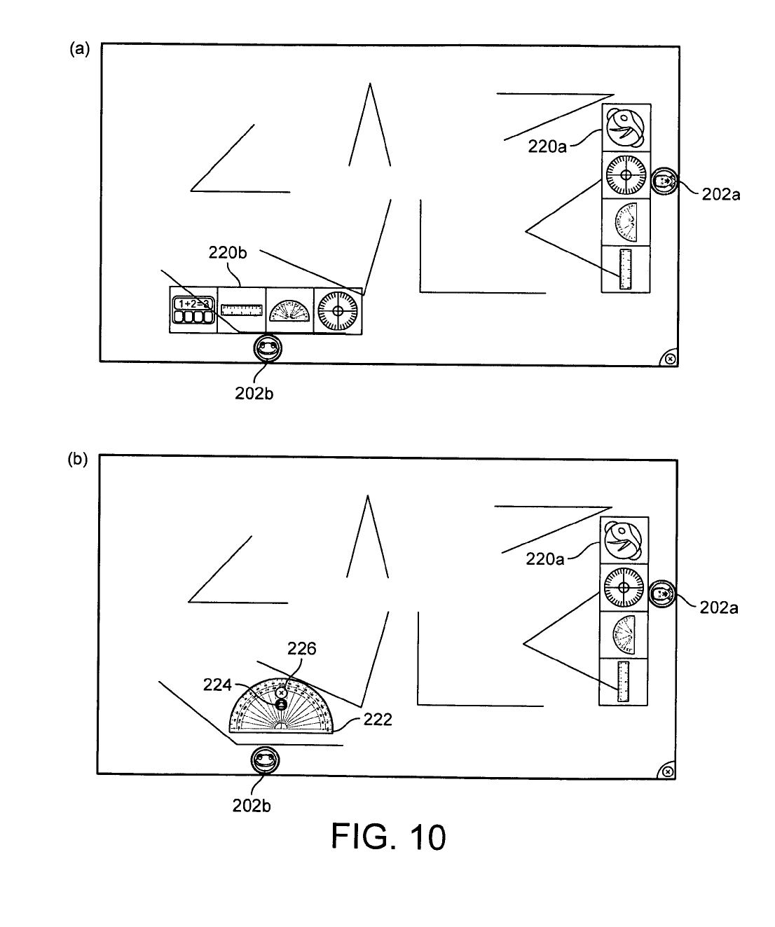

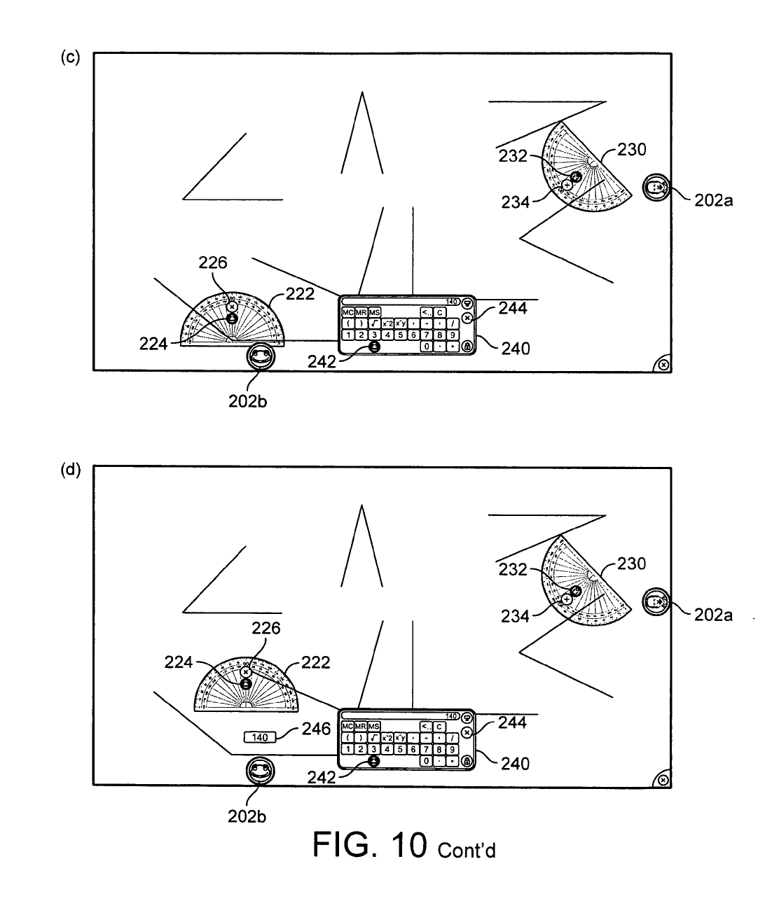

With reference to FIGS. 10(a) to 10(d) there is now illustrated an example operation of the use of an application on selection of user identities as described with reference to FIGS. 9(a) to 9(e).

FIGS. 10(a) to 10(d) shows a drawing application being run on the interactive display surface, and for which users associated with the tokens 202b and 202a may provide inputs. There is illustrated a number of lines displayed on the display surface. As illustrated, each of the tokens 202a and 202b is associated with a respective display tool menu 220a and 220b. As illustrated, various tools may be displayed in the menu, but only a subset of the available tools may be displayed at any one time. Thus the user may see additional tools for selection by scrolling the menus 220a and 220b left to right. As illustrated, for example, the available tools may include a ruler and a protractor. A user selects a tool by touching on the displayed icon for the tool which they desire, in their respective menu 220a and 220b.

As illustrated in FIG. 10 (b), the tool menu 220b is no longer displayed, as the user associated with the token 202b has selected a particular tool, and in particular has selected a protractor tool. Thus as illustrated in FIG. 10(b) a protractor 222 is displayed on the display surface, and with the protractor is displayed a small icon representing the user who has selected it, which in this example is a copy of the token with the user's avatar as denoted by reference numeral 224. Also displayed on the protractor 222 is an icon 226, which indicates a means for the user to deselect the tool. As illustrated in FIG. 10(b), the second user associated with token 202a has not selected any tool, and therefore the user's tool menu 220a is still displayed.

As illustrated in FIG. 10(c), the user 202a has now selected a tool, and therefore the tool menu 220a is no longer displayed. The user 202a has similarly selected a protractor as represented by reference numeral 230. The protractor 230 displays a copy of the token 202a as illustrated by icon 232, and an icon 234 with which the protractor may be deselected.

As additionally illustrated in FIG. 10(c), the first user associated with token 202b has now additionally selected a keyboard 240, and the keyboard is similarly displayed with an icon 242 being a duplicate of the token 202b, and an icon 244 with which the keyboard may be deselected.

In accordance with the principles as described earlier, any inputs detected and associated with the protractor 222 or the keyboard 240 is associated with the user associated with the user icon 202b. Any inputs detected as associated with the protractor 230 are associated with the user associated with the token 202a.

In FIG. 10(d), there is illustrated an icon 246 displaying a number (the number 140). This represents the result of a calculation performed using the keyboard 240. The keyboard 240 may be simply a calculator. This displayed answer as denoted by reference numerals 246 may be dragged to provide a label to a calculated angle. The application can determine that the answer has been provided by the first user associated with the token 202b, as it has been calculated using the keyboard 240.

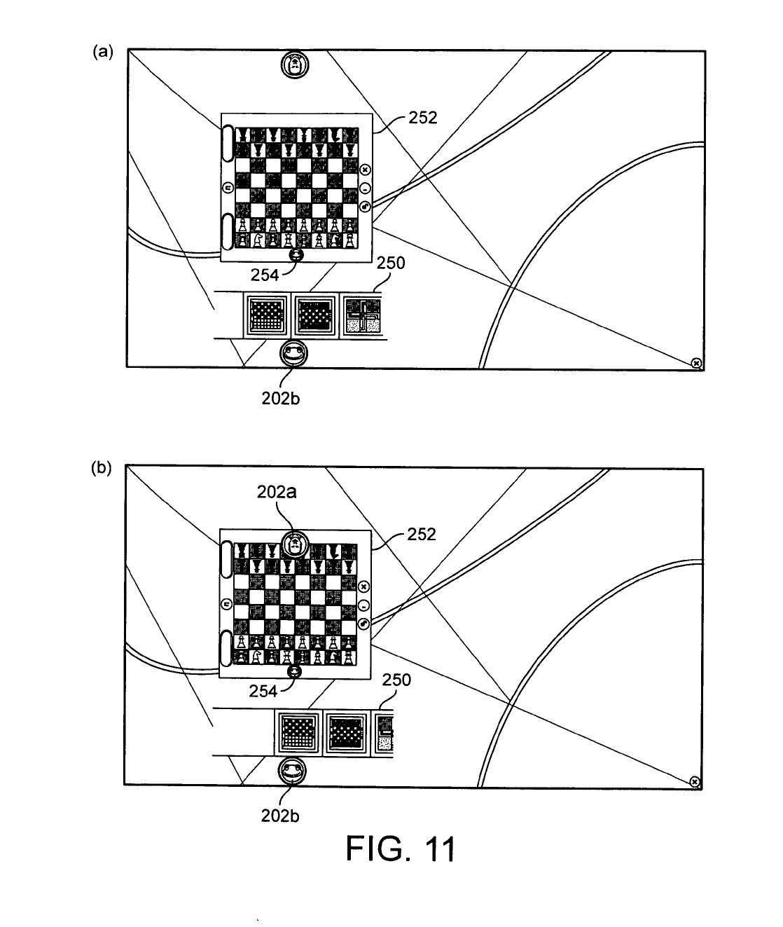

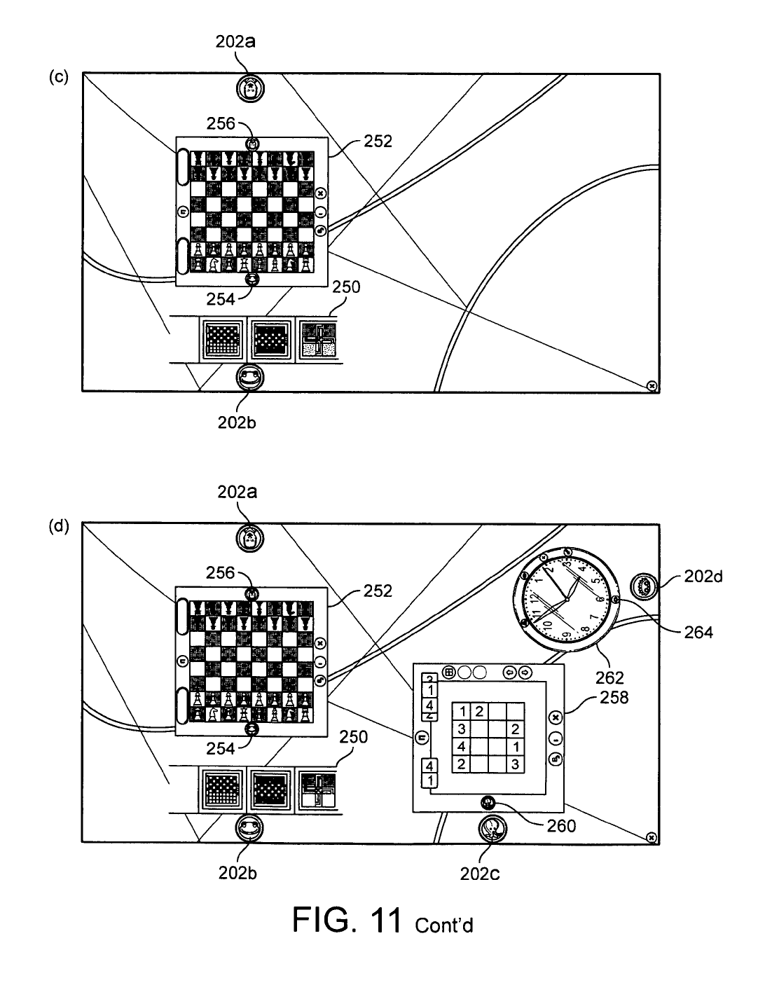

With reference to FIGS. 11(a) to 11(d) there is illustrated a further example in which the application which is being run is a game. As illustrated in FIG. 11(a), the user associated with the token 202b is provided with a games menu 250. As above, additional games may be displayed by scrolling the games menu 250 left and right. The user associated with the token 202b selects a game of chess, and the chessboard for the game is displayed as a displayed icon denoted by reference numeral 252. As can be seen in FIG. 11(a), the icon associated with the token 202b is additionally displayed on the chessboard, as noted by reference numeral 254. This preferably represents a duplicate of the token 202b.

As illustrated in FIG. 11(b), the user associated with the token 202a drags their token 202a onto the chessboard, to indicate that they wish to play the game of chess.

As illustrated in FIG. 11(c), the token 202a is then returned to a “docked” position at an edge of the display surface. A copy of the token 202a is then displayed on the chessboard, as denoted by reference numeral 256. The application now “knows” the identity of the two players who are to play the game of chess.

As illustrated in FIG. 11(d), additional users may carry out additional activities while the game of chess is played between the two users associated with the tokens 202a and 202b. As illustrated in FIG. 11(d), a user associated with a token 202c is playing a game as identified by reference numeral 258. The “ownership” of the game is indicated by the display of a copy of the token 202c as denoted by reference numeral 260 on the game. Similarly a user associated with the token 202d is associated with a clock 262, the association being confirmed by the display of a copy of the token 202d as the image 264 on the clock. Thus any inputs associated with the displayed game 258 are associated with the user and linked to the token 202c, and any inputs associated with the clock 262 are linked to the token 202d and the associated user thereof.

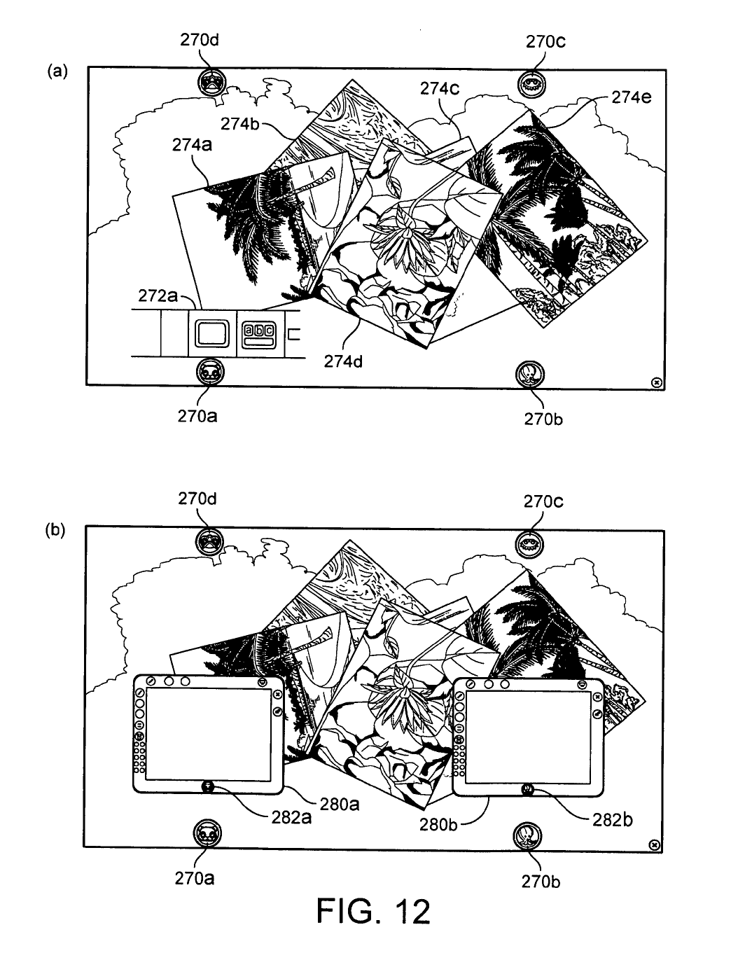

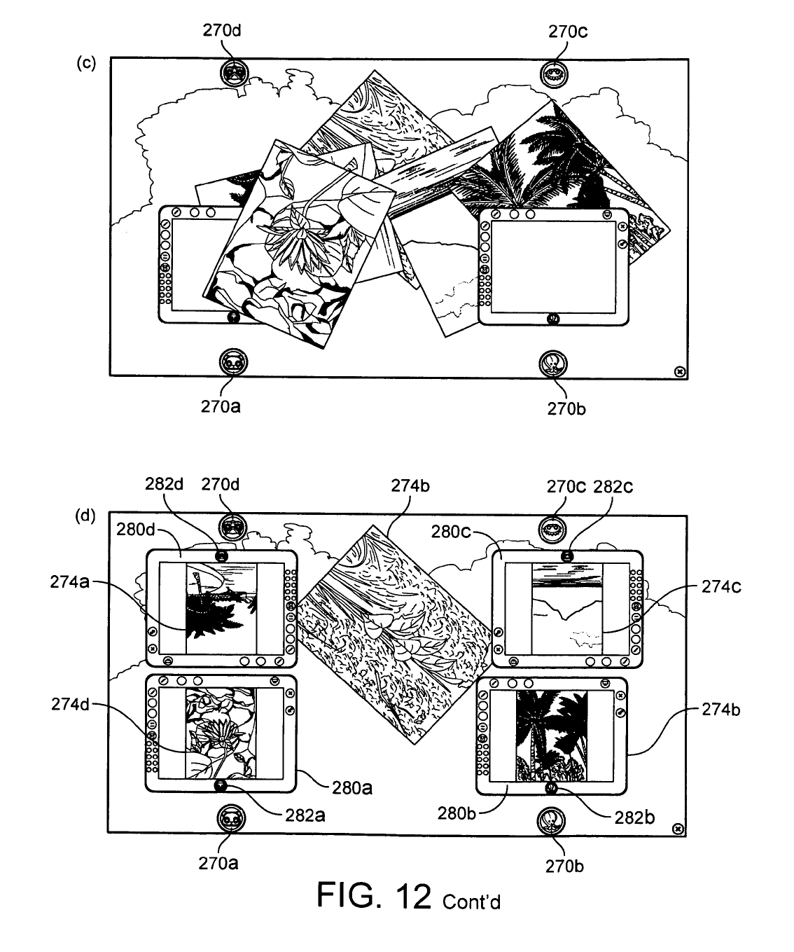

With reference to FIGS. 12(a) to 12(d) there is now described a further exemplary application, using multiple users with tokens, for image editing.

As illustrated in FIG. 12, there are four tokens denoted by reference numerals 270a to 270d, each of which has been associated with the user. In the example of FIG. 12(a) each user has selected a user identification using an avatar.

For the token 270a, there is additionally displayed a menu 272a with various options thereon associated with image editing. Again, the user may be able to display additional options by scrolling the menu left and right.

Also illustrated in FIG. 12(a) is a number of images, denoted by reference numerals 274a to 274e, generally displayed around the display surface, in an overlapping manner.

All users have in their tool options provided on the menu such as menu 272a for token 270a a work pad tool. The work pad tool is denoted by reference numerals 278 for the menu 272a.

In FIG. 12(b), it is illustrated that a work pad tool has been selected for each of the tokens 270a and 270b, the work pads being displayed on the interactive surface as denoted by reference numerals 280a and 280b. As in previous examples, the selected work pads have an association with the respective token identified, by providing a copy of the respective tokens 270a and 270b on the work pads 280a and 280b as denoted by reference numerals 282a and 282b.

As illustrated in FIG. 12(c), by virtue of a touch contact a user drags one of the displayed images, denoted by reference numeral 274d, over their work pad. The displayed image is then associated with the work pad to which it is dragged. In the example, as shown in FIG. 12, the image 274d is dragged over the work pad 280a, such that it is then associated with the token 270a.

Turning to FIG. 12(d), it can then be seen that the image 274d is now displayed within the work pad 280a, for anything by the user associated with the token 270a.

As further illustrated in FIG. 12(d), there is now displayed a work pad 280c and 280d associated with the tokens 270c and 270d, such association being indicated by a copy of the token being displayed on the work pad, as denoted by reference numerals 282c and 282d. Any user may select an appropriate image by touching and dragging that image over their work pad area, in order for that image to then be displayed within that work pad for further editing. Thus in the example of FIG. 12(d), the image 274a is dragged into the work pad area 280d, the image 274c is dragged into the work pad area 280c, and the image 274e is dragged into the work pad area 280b.

Once an image is dragged into a work pad area, then all editing of that image is carried out within the work pad area. On completion of imaging, the user may select the image and drag it into an area of the display surface outside of their work pad, in order to release the association of the image from the respective token.

All examples and embodiments described herein may be combined in various combinations, and are not mutually exclusive.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method of collaborative working at a touch sensitive surface of a collaborative input system, the method comprising:
a. selecting, by touch, at the touch sensitive surface, a displayed icon;
b. providing further inputs, by touch, at the touch sensitive surface, wherein the further inputs are associated with the selected icon.

2. The method of claim 1 wherein the further inputs are associated with the selected icon until a different icon is selected.

3. The method of claim 1 wherein the further inputs are associated with the selected icon until the selected icon is deselected.

4. The method of claim 1 further comprising the step, upon selection of the displayed icon, of associating the displayed icon with a user.

5. The method of claim 4 further including the step of a user registration process on selection of the displayed icon to identify the user.

6. The method of claim 1 wherein the step of selecting a displayed icon comprises selecting the icon and dragging the icon to an edge of the touch sensitive surface.

7. (canceled)

8. The method of claim 1, wherein upon selection a selected icon is oriented with respect to an edge of the touch sensitive surface.

9. (canceled)

10. The method of claim 1 wherein on selection the icon is positioned at a predetermined distance from an edge of the touch sensitive surface.

11. The method of claim 4, wherein upon selection of the displayed icon a plurality of identification options are provided for selection, wherein the selection of a further displayed icon confirms a user selection of the options.

12. (canceled)

13. (canceled)

14. The method of claim 1 wherein when there is selected a plurality of icons by a plurality of users, a user selection process being maintained until all users have confirmed the selection of any options for each of the plurality of selected icons.

15. The method of claim 1, further comprising repositioning the displayed and selected icon on the touch sensitive surface.

16. The method of claim 1 wherein a plurality of users select a plurality of displayed icons, wherein two or more of the plurality of selected icons are grouped.

17-19. (canceled)

20. The method of claim 1 wherein a selected user icon is deselected by dragging the displayed icon away from the edge of the touch sensitive surface.

21. (canceled)

22. (canceled)

23. The method of claim 1 further comprising the step of defining a plurality of active areas on the touch sensitive surface, wherein the active areas are defined by the selection of user icons.

24. (canceled)

25. (canceled)

26. The method of claim 1 further comprising the step of determining a position of a user associated with the displayed icon.

27. (canceled)

28. The method of claim 1 further comprising providing a plurality of displayed icons, each displayed icon being for association with a particular user identity.

29-75. (canceled)

76. A collaborative input system including a touch sensitive surface for receiving a plurality of touch inputs, adapted to: determine selection, by touch, of a displayed icon; detect further inputs, by touch; associate the further inputs with the selected icon.

77. The collaborative input system of claim 76 further adapted such that the further inputs are associated with the selected icon until a different icon is selected.

78. The collaborative input system of claim 76 further adapted such that the further inputs are associated with the selected icon until the selected icon is deselected.

79. The collaborative input system of claim 76 further adapted such that upon selection of the displayed icon, the displayed icon is associated with a user.

80-147. (canceled)
